(19) United States
(12) Patent Application Publication
(10) Pub. No.: US 2015/0227780 A1
(43) Pub. Date: Aug. 13, 2015

(54) METHOD AND APPARATUS FOR DETERMINING IDENTITY AND PROGRAMING BASED ON IMAGE FEATURES

(71) Applicant: FacialNetwork, Inc., Las Vegas, NV (US)

(72) Inventor: Kevin Alan Tussy, Las Vegas, NV (US)

(21) Appl. No.: 14/621,611

(22) Filed: Feb. 13, 2015

Related U.S. Application Data
(60) Provisional application No. 61/939,417, filed on Feb. 13, 2014.

(51) Int. Cl. G06K 9/00; G06F 17/30; G06K 9/62

(52) U.S. Cl. CPC G06K 9/00221; G06K 9/6201; G06F 17/30247

(57) ABSTRACT

Embodiments of a system and related methods are disclosed for identifying performers in a performance. The system takes one or more photos capturing faces of multiple performers in a performance and generates one photo for each of the faces. The system identifies the faces in a specific order by matching the generated photos against a database of photos of known performers in that order. The system reduces the number of photos against which each generated photo is matched by identifying the performance based on various factors, including the experience of the performers, the contents of the performance, and the play time and location of the performance. The system presents multiple identification results for each face in a specific order based on the match quality, promotional consideration, user preference, or other factors. In addition, based on a history of performance viewing and performer selection, the system recommends related performances and performers.

### CROSS-REFERENCE TO RELATED APPLICATION

This application claims the benefit of U.S. Provisional Patent Application No. 61/939,417, titled “Methods and Apparatus for Determining Identity and Programming Based on Image Features” and filed on Feb. 13, 2014, which is incorporated by reference herein in its entirety.

### TECHNICAL FIELD

This application is related to identifying people based on facial images, and, in particular, identifying performers in a performance.

### BACKGROUND

When viewing a television show, movie, image, picture, broadcast, print ad, billboard, or any other image of a person, the person viewing it (“viewer”) may wish to know the identity or information regarding an actor or model depicted in the image. However, due to a costume, makeup or difficulty remembering, the viewer may not be able to determine or remember the actor's name or identity. For example, when watching a movie or television show, the viewer may enjoy the acting of an actor, but may be unable to remember or not know the actor's name. This makes it very difficult for the viewer to identify other movies or television shows in which this actor appears, for example.

### SUMMARY

A system and related methods for identifying one or more people in a performance are disclosed. The system matches photos of people in a performance captured by a user device with photos of known performers in a database, using knowledge of those people's experience and/or of the performance to guide the database search.

In certain embodiments, the system obtains a plurality of photos which respectively depict faces in a performance of a plurality of performers. First, the system initializes a master list with predetermined performance titles. The system then performs the following steps until all the obtained photos have been selected. The system selects one of the obtained photos that has not been selected, matches the obtained photo with at least one photo in a database, each of which depicts a face of a performer who has appeared in at least one of the performances whose titles are on the master list. Next, the system determines a list of photos from the at least one photo as matching results. When a best of the matching results satisfies a predetermined condition, the system obtains a list of titles of performances in which the performer whose face is depicted in the best matching result appears and updates the master list of performance titles with the obtained list of performance titles.

In certain embodiments, the system receives a facial photo of an unidentified person in one scene of an unidentified performance. The system then determines a list of identified performances as potential matches of the unidentified performance. Next, the system compares the received facial photo with at least one facial photo in a database, where each of the at least one facial photo depicts a face of an identified person who has appeared in at least one of the identified performances, and each comparison produces a score. Finally, the system determines a list of facial photos from the at least one facial photo in the database each having a score above a predetermined threshold.

In certain embodiments, the client device of the system captures one or more photos depicting faces of a plurality of people in the performance. The client device then extracts a facial image for each of the plurality of people from the one or more captured photos. Next, the system sends the extracted facial images to a server over a network. In return, the client device receives a list of matches for each of the plurality of facial images from the server over the network, where each match contains a facial photo of a performer and identifying information of the performer, and at least some of the matches correspond to performers who have appeared in the same performance.

### BRIEF DESCRIPTION OF THE DRAWINGS

Various embodiments are disclosed in the following detailed description and accompanying drawings.

FIG. 1 illustrates an example of a system which analyzes an image having one or more faces in the image.

FIG. 2 illustrates a block diagram of an example of a mobile device for capturing photos and displaying photo matching results.

FIG. 3 illustrates an example of a screen display of a mobile device which shows photo matching results.

FIG. 4 is a flowchart illustrating an example of a process performed by a system of identifying a plurality of performers in a performance based on information regarding experience of the performers.

FIG. 5 is a flowchart illustrating an example of a process performed by a system of identifying a performer in a performance based on information regarding the performance.

FIG. 6 is a flowchart illustrating an example of a process performed by a mobile device of identifying a plurality of performers in a performance based on information regarding experience of the performers.

FIG. 7 is a high-level block diagram showing an example of an architecture of a computer, which may represent any electronic device, any server, or any node within a cloud service as described herein.

### DETAILED DESCRIPTION

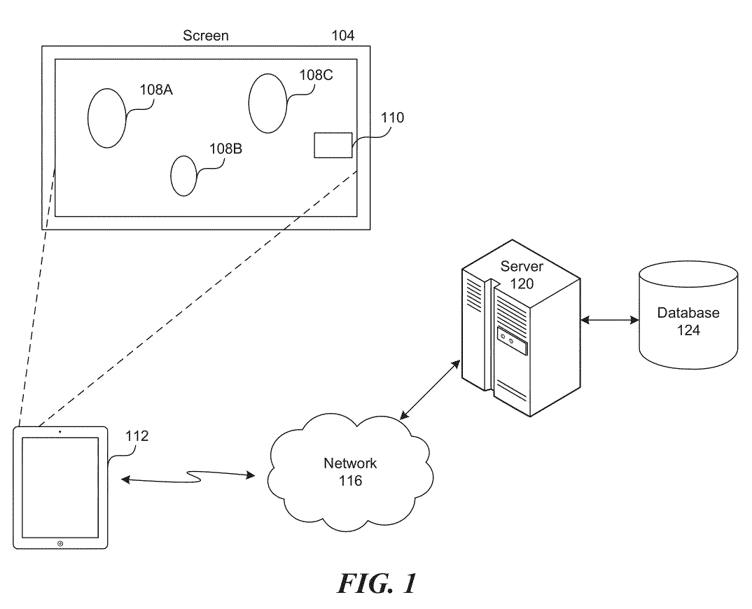

FIG. 1 illustrates an example of a system which analyzes an image having one or more faces 108 in the image. The image can originate from any source, such as on a theater screen 104, a picture, a billboard, or a poster. A mobile device 112 is capable of capturing an image of the screen 104 including the one or more faces 108 on the screen. The mobile device 112 is described below in greater detail.

The mobile device 112 is configured to wirelessly communicate over a network 116 with a remote server 120. The server communicates with one or more databases 124. The network can be any type network capable of communicating data to and from the mobile device. The server 120 can include any type of computing device capable of communicating with the mobile device 112. The server 120 and mobile device are configured with a process or memory and configured to execute machine readable code or machine instructions stored in the memory. The database 124 contains images of people.

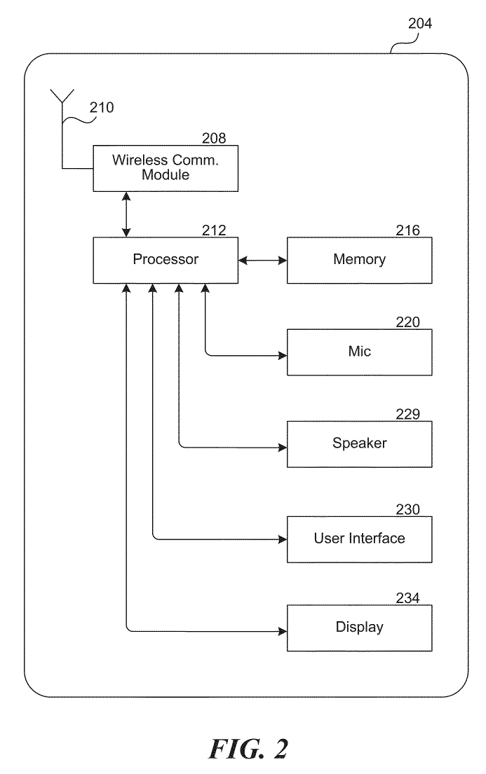

FIG. 2 illustrates a block diagram of an example of a mobile device. This is just one possible embodiment. Other mobile device configurations are possible. The mobile device 204 may be or include, for example, a smart phone, tablet, personal computer, laptop computer, or any other mobile device capable of functioning as described herein.

As shown in FIG. 2, the mobile device 204 includes an antenna 210 configured to send and receive wireless signals over a wireless network. The wireless signal may comprise computer network wireless signals, cellular data signals, or any other type of wireless transmissions. Although shown with an antenna it is contemplated that a wired connection (not shown) may exist.

The antenna 210 connects to a wireless communication device 208 which may comprise an analog front end in communication with an analog or digital baseband processing system. The wireless communication device 208 performs and oversees the wireless communication via the antenna. A processor 212 connects to the wireless communication module 208 and is configured to interface with the various components of the mobile device 204. The processor 212 is capable of executing machine readable code, for example software code, which is stored in a memory 216 and/or received from the wireless communication module 208. Any type of special purpose or general purpose processor may be utilized.

Also part of the mobile device 204 is a display 234 configured to present visual information to the user. Any type or size display 234 may be utilized. A user input device 230 is also present and capable of receiving user input. The user input device 230 may comprise buttons, keys, touch elements, dials, wheels, scroll balls or may be configured as part of the display 234, such as in the case of a touch screen.

A microphone 220 and speaker 224 also connect to the processor 212 as shown, which provide audio information to the user and capture audio information from the environment of operation and from the user. Any type microphone 220 having the capability described herein and speaker 224 may be utilized. The microphone 220 is configured to capture audio information which may include non-visual cues. These non-visual cues may optionally be buffered in memory or one more registers and processed by the processor 212. Also part of the mobile device 204 is a camera, which may capture video or still images. Associated with the camera may be a zoom feature, lenses, a charge-coupled device (CCD) or other capture element. A gyroscope may be part of the mobile device 204.

In operation, a mobile application comprises machine readable code residing on the memory 216 and is executed by the processor 212. The mobile application may receive a cue, such as an audio cue from the microphone 220, which triggers the execution of the mobile application.

In response to the cue, the processor 212 and communication module 208 will contact a remote server database via the wireless communication module 208 to retrieve information that is associated with the cue. It is also contemplated that an Internet browser may be utilized to communicate with the database or remote server. The remote server or database may be proprietary and accessible to only the mobile application or publicly accessible on the worldwide web.

Upon receipt of the requested information from the database or remote server, the processor presents the information to the user via the display 234 and/or the speaker 224. The user may use the user input device 230 to interact with the information including further research or browsing.

Numerous different modes of operation are possible using the hardware with associated software as described herein. Each mode or feature described below can be combined with any other mode or features that are described herein or known in the art. In the embodiments described herein, the process may start by a user activating a mobile device and activating or running a specific mobile application, referred to herein as ActorID.

### Automatic Screen Detection

In one method of operation the mobile device (which includes the associated software, such as an application) is pointed at a screen in which an image or a video is displayed so that the mobile device camera may capture a photo of the screen. To improve the facial detection and facial identification capability, the application is configured to automatically detect the edges of the screen. Thus, the ActorID application may detect the image presented from the camera and detect the screen or image of interest in the camera. This may occur by detecting one or more features of the recorded image which are indicative of a screen. For example, a television screen is typically surrounded by a black border and one of a limited number of aspect ratios. By comparing black frames in the image to known aspect ratios, a screen can be automatically detected by the application.

### Automatic Facial Detection Area Adjustment for Screen Size

The ActorID application may be further configured to automatically resize the area of a video feed that contains a screen in which an image or a video is and only run facial detection on that area to conserve processing resources on the device. This results in improved the facial detection and recognition process by limiting the amount of pixels the processor must scan and can result in smoother video on the mobile device and a higher potential frame rate. The resolution of the camera may also be adjusted upward or downward to balance accuracy and speed such that higher resolutions may result in higher accuracy, but reduce the speed of the system.

This feature provides the user with an automatic system for image capture of the screen thereby adapting to large distant screens, such as a movie screen, mid-field television screens, and smaller computer screens or pictures. It is contemplated that the mobile device may be placed in portrait or landscape alignment. In one embodiment the mobile devices uses image stabilization to improve the quality of the captured image.

In some embodiments, facial images can be obtained from images or videos available over networks or already received on a mobile device or Smart Television. For example, the ActorID application can review multimedia databases on the mobile device according to a schedule or continuously monitor the download of images or the streaming of videos onto the mobile device. The application can then scan any of these images or videos to detect faces within the image or the video. For video data, the application can extract frames in various ways. For example, where the video source is readily accessible, such as html5 video data, the application can retrieve entire scenes from the video source. In other cases, the application can take screenshots to capture entire scenes. The sampling of video data can be performed periodically, in a quick succession every time, etc., depending on the amount of processor load on the mobile device and other factors.

### Facial Detection and Facial Identification

The ActorID application may be configured with either or both of facial detection and facial identification. Facial detection is an algorithm which detects a face in an image. In contrast, facial identification is a method which associates a face with a person. In some embodiments, facial identification is a process in which facial features are analyzed and converted to biometric data, which is then compared to previously-stored biometric data. The biometric data can be compared to that derived from one or more different images for similarities or dis-similarities. If a high percentage of similarity is found between images additional information may be returned such as a name.

With the ultimate goal of matching a face in an image to an identity, such as the person's name, the ActorID application may first processes the image captured by the camera to identify and locate the faces that are in the image. As shown in FIG. 1, there may be three faces 108A, 108B, and 108C.

The portion of the photo that contains detected faces may then be cropped, cut and stored for processing by one or more facial identification methods. By first detecting the face in the image and cropping only that portion of the face or faces, the facial identification methods need not process the entire image. Further, in embodiments where the processing occurs remotely from the mobile device, much less image data must be sent over the network to the remote location.

In one embodiment the largest face as presented on the screen is captured and processed first, then faces that are smaller are next captured and processed. The processing may occur on the mobile device or at a remote server which has access to large databases of image data or facial identification data.

Facial detection software is capable of detecting a face from a variety of angles however facial identification methods are most accurate in straight on photos in well-lit situations. In one embodiment, the highest quality face photo for facial identification presented on the screen is processed first, and then photos of faces that are lower quality or at different angles other than straight toward the face are processed. The processing may occur on the mobile device or at a remote server which has access to large databases of image data or facial identification data.

The facial detection is preferred to occur on the mobile device and performed by the mobile device software, such as the ActorID application. This reduces the amount of image processing that would occur and is beneficial for the facial identification methods. Likewise, if transmitting to a remote server processing, bandwidth requirements are reduced.

It is contemplated that the facial identification processing may occur on the mobile device or the remote server, but is best suited for a remote server since it will have access to faster and multiple processors and access to the large databases required for actor identification, network data and the like.

In some embodiments, if the database of known matches is sufficiently limited, the database may be stored on the mobile device and the facial identification may be performed on the mobile device. For example, a large number of people suffer from memory issues, facial identification deficiencies, or Alzheimer's disease. These people may have a database of ‘trusted and known’ faces (people) which may be less than 20, or less than 100 or less than 200 people. Given this limited volume of people and associated data, the person having memory issues can scan the face of the person, either with camera equipped glasses or the mobile device camera to determine if the person with whom they are interacting is ‘trusted and known’ and provide a name for that person. This will help avoid confusion, increase safety, reduce fraud, and improve the quality of life for those people and those around them.

### Identify Actors on Screen and Identify Show

In some embodiments, the system allows a user to receive information regarding one or more people in an act or a performance to which the user is exposed. In one configuration when attempting to identify actors on a screen that are wearing glasses, prosthetics, costumes or makeup sufficient to reduce the accuracy of the facial identification methods, such as in a movie or television show on a screen, the first step towards identifying the actors in a movie is identifying the movie. By identifying the movie, the subset of potential actors in that particular movie is greatly reduced in size. Through the ActorID application, the mobile device initially captures a screen image and detects the one or more faces. The portions of the faces may be cropped and either processed locally or in some embodiments sent over the network to a server which is configured to access a database of images. Only the cropped portion may be sent to the remote database to reduce bandwidth requirements and speed processing. When a high percentage match for an actor in the movie is found, a second photo is processed by the facial identification method and the films and movies for the first actors are used to create a subset of actors that also appear in films or movies with the first actor. If a high percentage match is found within the subset the show or movie can be predicted with a high percentage of certainty. If a high percentage match is not found another photo of the same or a different actor can be captured or the search can be expanded outside the subset. Then the movie or show name that has been predicted can be verified by the user and if subsequent photos are scanned they can be found within the actors who appear in that show. By limiting the subset of possible actors the identity of actors with makeup, prosthetics or other facial identification limiting factors can be predicted with higher certainty.

The remote server performs facial identification on the one or more faces that are depicted by the mobile device. During the movie identification process the ActorID application may continually send images to the remote server, in the form of cropped faces from the paused or continually moving image. The more facial image data is provided for processing, the more accurate the facial identification is.

The image processing software on the remote server compares the image of the face extracted from the movie to a database of known actor images to determine a match. An actor list of possible matches may be made. This process may also occur on a second or third face from the movie. An actor list of possible matches from these faces may also occur to thereby establish a list of names.

Next, a master list may be defined as the list of all actors that have been identified in the movie. Each actor may have a probability of accuracy or rating. Next, a movie database is cross-referenced to determine which movies include all of the actors identified in the master list. If only two movies contain all the actors, then there is a high probability that the movie from which the images were generated is one of these two movies. In many instances, only one movie or show will contain all the identified actors. As more actors are identified in the movies, the list of possible movies is further reduced until a single match is identified. This may be referred to as compounding probability where one or more detectable or knowable aspects of the movie or show are added to the processing algorithm to improve accuracy.

Once a first actor is identified with accuracy, such as some probability as set by the user or the system administrator, the list of possible movies may be shortened since a particular actor will appear in a limited set of movies or shows.

Upon identifying the actor list for a particular face and the most likely match for the movie or show, the remote server may transmit the data to the mobile device for display to the user. The data may include one or more pictures and names of the actors which match the face and a list of one or movies. The user may then use this data to identify other movies in which the actor of interest appears, order the movie or purchase for download, or obtain other purchase or advertising options.

### Additional Matching Routines

In one embodiment, audio of the show in captures for names using voice recognition software routines. If a name of an actor is identified, the name of that actor is compared to the names of the character in the movie or show to determine a likely match for the actor.

In one embodiment, one or more other elements on the screen is processed to determine a channel or other feature. For example, a logo may be presented on the screen and the logo may be used to identify a channel or a program being watched. If the network is known, then the list of possible shows may be narrowed by comparing the network's programming to the other data that was already detected. For example, it has been determined that if the network logo, often located in the lower corner of the screen is determined by image recognition and one actor, the show being watched can also be determined with a high amount of certainty. Once the show is determined, the other actors can be cross referenced against the predicted show to improve the accuracy of the prediction. In one embodiment the software application, either on the mobile device or the remote server may access one or more actor database, movie and show databases, network databases, movie databases, model databases, professional or college athlete databases or musician databases to obtain information for actor and show/movie match.

In one embodiment, the time of the program or when the screen capture is taken can be used, but this additional item of information is limited by DVR and other recording devices which time shift.

In one embodiment, the user's location is determined, such as by GPS or other means and this data is used to determine the actor, movie or show. For example, if a show or movie is only playing in theatres or in only one geographic area of the country, and the viewer is not in the geographic area, then it is unlikely that the screen capture is of that particular movie. Thus, this is another factor that can be used by the software to eliminate possible movie, show, or actor matches, thereby improving accuracy.

Similar automated subset creating features can be applied to real time facial identification in general, such that if a person of interest's location and/or people with which they are associated are known, the likelihood of a correct facial detection is increased.

### Multiple Frame Captures

It is contemplated that more than one screen capture may occur when the user is pointing the mobile device's camera at the screen. This improves accuracy of facial identification by allowing the actor's face to be captured during different frames and thus at facial positions, different angles and in different lighting. Hence, although the user may simply point the camera at the movie for 5 seconds, during those 5 seconds many facial crop photos may be captured of the same or different actors, all of which are presented to the remote server for processing. Having six crops each of three different actors improves actor and movie prediction accuracy. This may be referred to as use of past and future frames.

### Language

In one embodiment the language or the voice of the actor is detected and processed as described herein. Using voice recognition, a voice match may be made to one or more actors to aid in the identification of the actor or show.

### QR Code or Other Code

In one embodiment, a QR code or any other visual code, whether visible to the viewer or not, may be provided on the screen and detected by the mobile device camera. Upon detection, it may be processed in the mobile device or transmitted to a remote location. The code may provide any level of detail about the movie to the movie itself, actor information, or any other data. The QR code can change in real time during showing of the movie or show to correspond to the actors in the scene or the events occurring on the screen.

In one embodiment the code or the face of a contestant may be used for the viewer to vote, such as in an American Idol® type competition, or for product or show reviews and feedback. Viewership may also be monitored by the number of database queries during a program.

### Text Based Network Guide

It is further contemplated that using character recognition, a viewer may display the info or guide during a show and use the camera of the mobile device to record this information. Then, using the text recognition, similar to optical character recognition, the screen text information can be analyzed to determine the show or one or more other features of the show, such as but not limited to channel, time of show, date of show (if time shifted), actors, network, internet site, cable or satellite provider.

### Mobile Device Owner's or User's Viewing History

In one embodiment, the ActorID application executing on the mobile device may be associated with either a mobile device or a user's account. Use by a user is recorded and tracked and viewing preferences are maintained such that when determining an actor's identify or a show being watched, the user's past viewing history is a factor in determining the best match. For example, although stereotypical but mathematically accurate, a viewer with a history of watching romantic comedies, cooking shows, and movies from the Victorian period may be less likely to watch a horror show than another romantic comedy if both movies include the same actor. Also the past TV show or Movie Ratings may be used to determine a subset for relevant show types. For example if a user's account has up to this point only scanned actors in movies that had a MPAA rating of “G” is highly unlikely that the next actor they scan will be in a movie with the MPAA rating of “R”.

### Other Factors for Movie or Show Identification

In one embodiment the video capture, irrespective of facial data, may be compared to a database of movies, shows, and other images to determine the show and the actors in the image. For example, each show will likely have a unique screen display on a scene by scene basis. Although processing intensive, the captured screen shot or video stream may be compared to a database of all known video or pictures to determine the movie, show, or image.

### Features Once Movie or Show is Known

Once a movie or show is known to the ActorID application, several beneficial features may be enabled and offered to the user. In one embodiment, the system may track, based on an image recorded on the user's mobile device to determine the point in the movie that the user is viewing to develop a time stamp. Using this time stamp, the user may then access the video on a different service and begin watching the movie or show at the sample time point in the movie. Unlike other services, which are limited to use with the same service, this proposed method of operation allows the user to be watching the movie or show on a television network, record the image to develop a time stamp that is mapped into the movie, and then access the movie on a movie streaming service, such as Netflix™, or Amazon™ streaming. This could also be the case for a preview of a movie, a program at a friend's house, or a movie on a plane when traveling.

In some embodiments, the ActorID application can work for the owner of a recorded performance or a film to detect potential copyright infringement on the web. Initially, the application processes a copy of the recorded performance or the film to extract facial images. The application can then store these facial images locally on the mobile device or send them to the remote server for storage. Subsequently, the application can automatically scan video footages on the web, by sampling all newly uploaded videos on some of the popular video websites periodically, for example. The application then extracts facial images from the sampled fames, and it can locally process the facial images or send them to the remote server, to determine whether these facial images match the facial images extracted from the owner's copy. Upon finding a match, the application can perform further sampling from the source of the sampled frames and/or display an alert to the owner on the mobile device. The owner can then determine whether the source has any right to the owner's recorded performance or film and take legal actions as necessary. By focusing on facial images, the application reduces the amount of time it takes to determine whether each video under consideration contains any material from the recorded performance or film.

In some embodiments, when a person owns multiple videos, the ActorID application can work for the owner to organize the videos. Initially, the application processes each video to extract facial images. The application then sends the extracted facial images to the remote server to recognize the faces depicted in the facial images. In response, the remote server produces names of performers corresponding to the faces depicted in the facial images, which can then be used to tag the video. These tags can facilitate the search of the multiple videos, for example. For each of those performers, the remote server can produce further information to be captured in the tags, such as the amount of appearance or the initial time of each appearance in the video.

### Screen Display

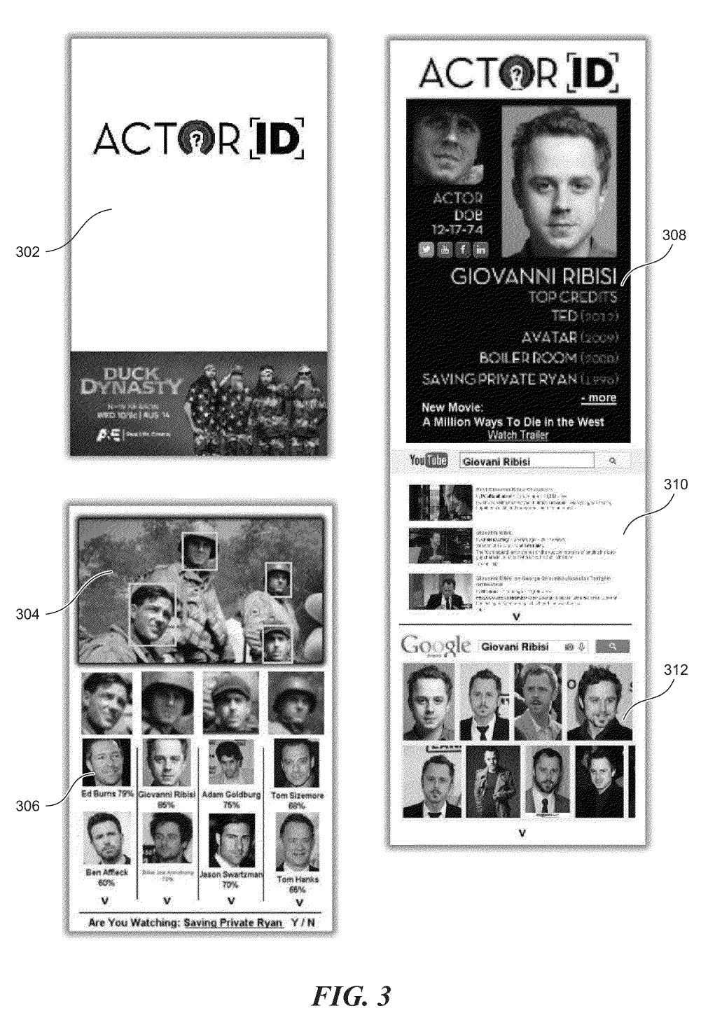

FIG. 3 illustrates an example of three screen displays of a mobile device as a client device within the system which shows photo matching results. The illustrative screen display 302 on the upper left portion corresponds to an initial screen displayed by the ActorID application. The illustrative screen display on the lower left portion shows a photo 304 captured by a user device, which contains the faces of several actors delimited by the system with rectangles. The illustrative screen display also shows identification results 306, where each column corresponds to one of the detected faces, with the top photo being the cropped image containing the detected face and the rest of the photos being good matches from a database typically on a server within the system. Each of the matching photos is accompanied by information shown below including the name of the person whose face is in the photo and a matching score. The illustrative screen display on the right portion corresponds to a screen that is displayed when the user clicks on one of the matching photos. In this example, the top pane 308 of the screen shows the matching photo and some information about the person whose face is depicted in the matching photo, the middle pane 310 shows a list of video clips of the person's performances, and the bottom pane 312 shows a list of the person's photos that are available from a web search.

### Promoted or Preferred Association

It is also contemplated that when an actor is identified and reported to the user, one or more other “possible matches” may be presented to the user and other actors that are similar or that my look like the identified actor. This may occur even when the probability of the identified actor being properly identified is very high. As such, it is possible to identify one or more additional possible matches on a promoted or preferred basis. As a result, the user would be provided the correct match actor, but also one or more additional matching actors, referred to herein as a second match, or third match, that while not the requested actor (and first match), are provided by the system based on a request by the second match actor, or by a network, or a movie studio. This second match actor may be provided to promote the actor or promote an upcoming movie. In one embodiment, the second match actor, network or movie studio may pay to be the second match actor. This would present and promote an actor to the public which can be desirable, or present other actors that are in similar roles or similar movies, or present an actor next to or in association with a famous person.

In one embodiment, the promoted or preferred association only occurs when the first match actor is a high confidence match to avoid providing a second match actor that is other than a second match actor that really has a high probability of being the actor of interest. In one embodiment a high confidence match is 95% or higher while in another embodiment it only occurs at a 99% or higher.

### User Profile, User Data, and Providing Product Information to User

In various embodiments, data tracking and monitoring will occur to improve system operation and provide user feedback to networks, movie studios, or other content delivery providers. For example, each user may have an account and based on viewing habits obtained from scan and facial identification requests, the user's viewing preferences can be determined. Based on the user's viewing preferences additional shows or movies may be proposed to the user to help the user and to provide targeted marketing.

Likewise, product proposals and marketing may be provided based on the user's viewing preferences, such as products that relate to or appear in the shows or movies watched by the user. Services could likewise be presented.

The data regarding which shows or movies are most scanned may also be provided to the networks and movie studios to provide feedback to the content providers regarding which shows or movies are most popular and which actors are most popular. An actor's scan popularity can also be used, or since the viewer does not know the actor, to determine which actors are popular or of interest, but not known by the public. Additional advertising may be required to acquaint the public with that particular actor.

In addition, one or more products, services, charities, interest, hobbies, or other aspect that are associated with the actor, show, or movie may be displayed or presented to the user when that movie, show, or actor is scanned and presented for recognition. Live information regarding the move, show, or actor can also be gathered in real time and presented together with known information. Such live information, which is often an indicator of popularity, can include statistics on data produced by online search engines (number of queries made, corresponding number of hits, etc.), fan resources (webpages, blogs, etc.), social media (likes, tweets, etc.), broadcast media (interviews, news programs, etc.), and so on. For image or video sources, such as television interviews, the ActorID application can be used to scan the contents of these sources, as discussed previously. Alternatively, the scanning can be performed by the remote server and the results can be shared by multiple mobile devices running the ActorID application.

The presentation of relevant information about the actor, show, or movie can occur in real time at the time of scanning, or by e-mail, text, tweets, user account update, or any other means. Thus, if watching a movie, an e-mail could be sent to the user when the user scans the actor or movie including details about the movie or actor, and a list of products used in the movie (with associated links for purchase of the product), or a list of locations in which the movie was filmed (with associated links for booking travel to these locations), or a list of services available which are similar to the services shown in the movie (with associated links for obtaining the services near the location of the user). The user may also make specific product or service information request.

To further increase user interest and enjoyment, a game may be made of the system by having users guess an actor's identity and other movies, in which the actor has appeared, or any other actor or movie/show related data. The user's answers can be determined by cross-referencing the remote database and points awarded to the user with the most correct answers. A show could make additional content available such a deleted scenes or a live chat with the director if the user successfully scans all of the main characters in a show.

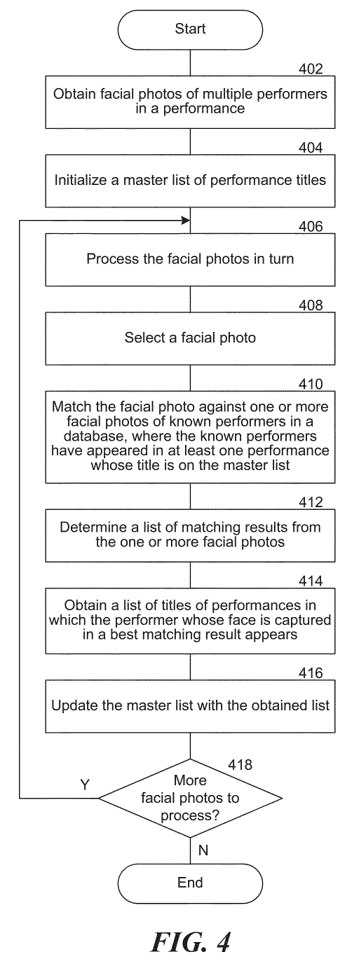

FIG. 4 is a flowchart illustrating an example of a process performed by the system of identifying a plurality of performers in a performance based on information regarding experience of the performers. In step 402, the system obtains facial photos of multiple performers captured during a performance. These photos can be shot by the system or received from a remote device. In step 404, the system initializes a master list of performance titles. The system maintains a database of facial photos of known performers along with information regarding the performers. Depending on how the master list is used to guide the search of facial photos in the database for matches of the obtained facial photos, the system can initialize the master list with all known performance titles, no performance title, or anything in between.

In step 406, the system starts processing the obtained facial photos one by one to find matching facial photos in the database. In step 408, the system selects one of the obtained facial photos that has not been selected. In step 410, the system matches the selected facial photo with one or more facial photos in the database which depict faces of those performers who have appeared in at least one performance whose title is on the master list. The match can be performed using any facial recognition techniques known to someone of ordinary skill in the art. Since the master list is typically much shorter than the list of titles of all known performances, this master list limits the scope of the search for matching photos and thus increases the efficiency of the search. In step 412, the system determines a list of matching results from the one or more facial photos in the database. Each match typically produces a score indicating how good the match is. Therefore, the system adds a facial photo to the list of matching results only when the corresponding score is sufficiently high, for example.

In step 414, the system identifies the best matching result, typically the one with the highest score, and obtains the list of titles of performances in which the performer whose face is depicted in the best matching result appears. The system can also identify more than one best matching result and obtains a potentially bigger list of performance titles accordingly. The system may retrieve this list of performance titles from the database. Alternatively, the system can generate the list from a web search or obtain this list from external sources in real time. In step 416, the system then updates the master list of performance titles with the obtained list of performance titles corresponding to the best matching result. When the master list is shortened by retaining only those performance titles that are on the obtained list, the master list then reflects the list of common performances among the performers to which the obtained facial photos which have been processed correspond, or to which their best matching results correspond. In step 418, the system determines whether any of the obtained facial photos still needs to be processed. The system repeats the above-described process until all the obtained facial photos have been processed and a list of matching results for each of the obtained facial photos have been determined.

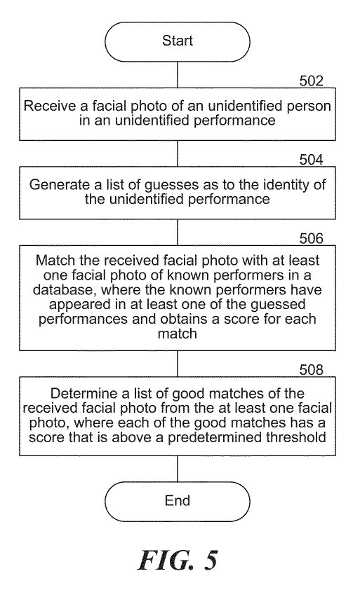

FIG. 5 is a flowchart illustrating an example of a process performed by the system of identifying an unidentified person in an unidentified performance based on information regarding the unidentified performance. In step 502, the system receives a facial photo of an unidentified person in an unidentified performance. In step 504, the system generates a list of known performances which may coincide with the unidentified performance in various ways. As one example, the system can obtain information on the current time and the current location of a device at or near the location of the performance, and generates a list of performances which play at the current time and location. As another example, the system can obtain another photo of the performance depicting a logo or the name of a director, and generates a list of performances produced by the company represented by that logo or directed by that director. In step 506, the system matches the received facial photo with at least one facial photo in a database of known performers who have appeared in the performances on the generated list. The match can be performed using any facial recognition techniques known to someone of ordinary skill in the art. Since the generated list of known performances tends to be much shorter than the list of all known performances, this list limits the scope of the search for facial photos in the database that match the received facial photo and thus increases the efficiency of the search. Each match typically produces a score indicating how good the match is. In step 508, the system determines a list of matching results for the received facial photo, typically those associated with relatively high match scores, from the at least one facial photo in the database. Subsequently, the system can display the list of matching results or transmit it to the device from which the facial photo was received initially.

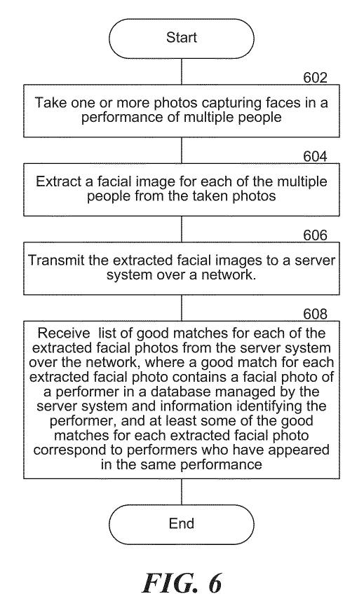

FIG. 6 is a flowchart illustrating an example of a process performed by a mobile device as a client within the system of identifying a plurality of performers in a performance based on information regarding experience of the performers. In step 602, the mobile device takes one or more photos of the faces of multiple people in a performance. The one or more photos can include a photo of a scene where multiple people appear, a photo of a scene where one person appears, or a combination of both. In step 604, the mobile device produces from the one or more photos individual facial images each of which depicts the face of one person only. In step 606, the mobile device transmits these facial images to a remote server within the system over a network, such as a cellular network, a Wi-Fi network, or any other feasible network. While the remote server may process these facial images one by one, it can be advantageous to send them all at once to the remote server so that the remote server can take advantage of information related to all the facial images. In step 608, in return, the mobile device receives a list of identification results for each of the facial images from the server over a network. An identification result for a facial image typically contains at least a facial photo in a database managed by the remote server that is a good match of the facial image and information identifying the performer whose face is depicted in the facial photo. In addition, the server has made sure that at least some of the identification results for a facial image correspond to performers who have appeared in the same performance.

### Submission of Non-Actors into Actor or Famous Person Database

The system may be used to submit other people, such as friends and family, to the actor database to determine which actor looks most like the submitted person. Or, a person can submit their own picture. Once submitted, the system operates as described above to reveal actors, or other individuals in the database who look like the submitted person. Thus, the user can see which actor they most resemble, or which actor their friends or family most resemble.

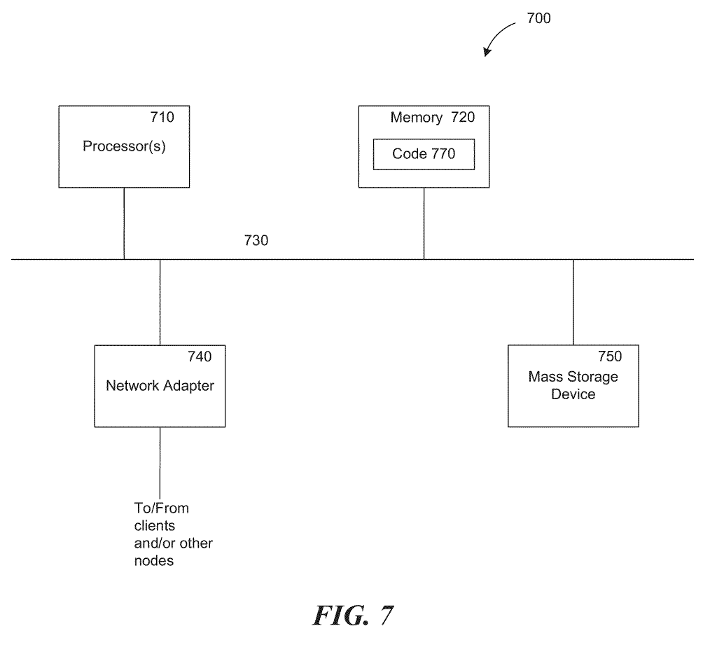

FIG. 7 contains a high-level block diagram showing an example architecture of a computer, which may represent any electronic device, such as a mobile device or a server, including any node within a cloud service as described herein, such as may implement the operations described above. The computer 700 includes one or more processors 710 and memory 720 coupled to an interconnect 730. The interconnect 730 shown in FIG. 7 is an abstraction that represents any one or more separate physical buses, point to point connections, or both connected by appropriate bridges, adapters, or controllers. The interconnect 730, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The processor(s) 710 is/are the central processing unit (CPU) of the computer 700 and, thus, control the overall operation of the computer 700. In certain embodiments, the processor(s) 710 accomplish this by executing software or firmware stored in memory 720. The processor(s) 710 may be, or may include, one or more programmable general-purpose or special-purpose microprocessors, digital signal processors (DSPs), programmable controllers, application specific integrated circuits (ASICs), programmable logic devices (PLDs), field-programmable gate arrays (FPGAs), trusted platform modules (TPMs), or a combination of such or similar devices.

The memory 720 is or includes the main memory of the computer 700. The memory 720 represents any form of random access memory (RAM), read-only memory (ROM), flash memory, or the like, or a combination of such devices. In use, the memory 720 may contain code 770 containing instructions according to the techniques disclosed herein.

Also connected to the processor(s) 710 through the interconnect 730 are a network adapter 740 and a mass storage device 750. The network adapter 740 provides the computer 700 with the ability to communicate with remote devices over a network and may be, for example, an Ethernet adapter. The network adapter 740 may also provide the computer 700 with the ability to communicate with other computers.

The code 770 stored in memory 720 may be implemented as software and/or firmware to program the processor(s) 710 to carry out actions described above. In certain embodiments, such software or firmware may be initially provided to the computer 700 by downloading it from a remote system through the computer 700 (e.g., via network adapter 740).

### CONCLUSION

The techniques introduced herein can be implemented by, for example, programmable circuitry (e.g., one or more microprocessors) programmed with software and/or firmware, or entirely in special-purpose hardwired circuitry, or in a combination of such forms. Software or firmware for use in implementing the techniques introduced here may be stored on a machine-readable storage medium and may be executed by one or more general-purpose or special-purpose programmable microprocessors.

In addition to the above mentioned examples, various other modifications and alterations of the invention may be made without departing from the invention. Accordingly, the above disclosure is not to be considered as limiting, and the appended claims are to be interpreted as encompassing the true spirit and the entire scope of the invention.

The various embodiments are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

A “machine-readable storage medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatuses, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

What is claimed is:

1. A method of identifying a plurality of performers in a performance, comprising:
obtaining a plurality of photos which respectively depict faces in the performance of the plurality of performers;
initializing a master list with a predetermined performance title; and
performing, by a computing system, the following steps until all the obtained photos have been selected:
selecting one of the obtained photos that has not been selected;
matching the selected photo with a photo in a database,
wherein each matched photo in the database depicts a face of a performer who has appeared in a performance whose title is on the master list;
determining a list of photos from matched photos in the database as matching results for the selected photo; and
when a best of the matching results satisfies a predetermined condition,
obtaining a list of titles of performances in which the performer whose face is depicted in the best matching result appears, and
updating the master list of performance titles with the obtained list of performance titles.

2. The method of claim 1, wherein the selecting includes selecting an obtained photo containing a largest face or having a highest facial-detection quality out of the obtained photos that have not been selected.

3. The method of claim 1,
wherein a matching result is associated with a score indicating how good the match is,
wherein the best matching result is a matching result associated with a highest score, and
wherein the predetermined condition is a numerical threshold.

4. The method of claim 1, further comprising when the best matching result does not satisfy the predetermined condition:
obtaining a replacement photo depicting the same face depicted in the best matching result, and
repeating the process starting with the matching for the replacement photo.

5. The method of claim 1, further comprising:
obtaining a background photo depicting graphics or text in a scene of the performance;
identifying the graphics or text in the background photo;
generating a list of performance titles based on the identified graphics or text; and
updating the master list of performance titles with the generated list of performance titles.

6. The method of claim 5, wherein the graphics corresponds to a logo representing a production company or a QR code for the performance, and the text indicates a title or credits of or a dialog in the performance.

7. The method of claim 1, further comprising:
obtaining information on a location and time related to a performance;
generating a list of performance titles based on the obtained time and location; and
updating the master list of performance titles with the generated list of performance titles.

8. The method of claim 7, wherein the location corresponds to a location of a theater and the time corresponds to a show time of a performance at the theater.

9. The method of claim 1, further comprising:
receiving a list of performance titles from a user; and
updating the master list of performance titles with the received list of performance titles.

10. The method of claim 1, further comprising:
adding to a full list of performance titles the master list of performance titles; and
determining a full list of performance categories to which the performances whose titles are on the full list of performance titles belong.

11. The method of claim 10, further comprising displaying or transmitting to a client device a list of titles of recommended performances that belong to the performance categories on the full list of performance categories.

12. The method of claim 1, further comprising:
adding to a full list of matching results the list of matching results; and
determining a full list of performer categories to which the performers whose faces are depicted in the matching results on the full list of matching results belong.

13. The method of claim 12, further comprising displaying or transmitting to a client device a list of photos of recommended performers who belong to the performer categories on the full list of performer categories.

14. The method of claim 1, further comprising determining an order for the list of matching results based on one or more of a match quality, a promotional consideration, and a user preference.

15. The method of claim 1,
wherein the obtaining includes receiving the plurality of photos from a mobile device, and
wherein each photo in the database is stored together with information regarding the performer whose face is depicted in the photo, including a name and a list of titles of performances in which the performer appears,
further comprising sending to the mobile device the lists of matching results and the information regarding the performers whose faces are depicted in the matching results.

16. The method of claim 15, further comprising:
for each of at least some of the matching results, computing an amount of online media coverage for the performer whose face is depicted in the matching result,
wherein the information regarding the performer whose face is depicted in the matching result includes the computed amount of online media coverage for the performer.

17. The method of claim 1, wherein the computer system is a mobile device, a cloud-computing platform, or a server farm.

18. A system for identifying an unidentified person in an unidentified performance, comprising:
a processor and memory, cooperating to function as:
a receiving unit configured to receive a facial photo of the unidentified person in the unidentified performance;
a determining unit configured to determine a list of identified performances as potential matches of the unidentified performance;
a comparing unit configured to compare the received facial photo with a facial photo in a database to produce a score,
wherein each compared facial photo in the database depicts a face of an identified person who has appeared in one of the identified performances; and
an identifying unit configured to identify a list of facial photos from compared facial photos in the database each associated with a score above a predetermined threshold.

19. The system of claim 18, further comprising
an obtaining unit configured to obtain a photo of graphics or text in the unidentified performance, information regarding a location and time related to the unidentified performance, or a user specification of a performance,
wherein the determining unit determines the list of identified performances based on the obtained data.

20. The system of claim 19, wherein the graphics corresponds to a logo representing a production company or a QR code for the unidentified performance, and the text indicates a title or credits of or a dialog in the unidentified performance.

21. The system of claim 19, wherein the location corresponds to a location of a theater and the time corresponds to a show time of a performance at the theater.

22. A computer-readable storage medium whose contents are capable of causing a computer device with a processor and memory to perform a method of identifying a plurality of people in a performance, the method comprising:
obtaining one or more images depicting faces in the performance of the plurality of people;
extracting, by the computer device, a facial image for each of the plurality of people from the obtained one or more images,
sending, by the computer device, the extracted facial images to a server system; and
receiving, by the computer device, a list of matches for each of the plurality of people from the server system,
wherein each match contains a facial photo of a performer and identifying information of the performer, and
wherein at least some of the matches correspond to performers who have appeared in the same performance.

23. The computer-readable storage medium of claim 22, the method further comprising
obtaining an image depicting graphics or text in the performance for identifying the performance; and
sending the obtained image depicting the graphics or text to the server system.

24. The computer-readable storage medium of claim 22, the method further comprising
determining a current location and time; and
sending the determined data to the server system.

25. The computer-readable storage medium of claim 22, the method further comprising
displaying each list of matches in an order,
wherein the order of the matches is based on one or more of a match quality, a promotional consideration, and a user preference.

26. The computer-readable storage medium of claim 22, wherein the computer device is a mobile device.

27. The computer-readable storage medium of claim 22, wherein the obtaining includes capturing a photo, reading an image stored on the computer device, or extracting a frame from a video playing on the computer device.
